(19) United States
(12) Patent Application Publication
(10) Pub. No.: US 2019/0220417 A1
(43) Pub. Date: Jul. 18, 2019

(54) Context Switch Optimization

(71) Applicant: Apple Inc., Cupertino, CA (US)

(72) Inventors: David J. Williamson, Austin, TX (US); Deepak Limaye, Austin, TX (US); James N. Hardage, Austin, TX (US)

(21) Appl. No.: 15/874,624

(22) Filed: Jan. 18, 2018

(51) Int. Cl. G06F 12/12; G06F 9/46; G06F 8/41; G06F 9/30; G06F 9/38

(52) U.S. Cl. CPC G06F 12/12; G06F 9/461; G06F 9/3851; G06F 9/3009; G06F 8/433

(57) ABSTRACT

In an embodiment, a processor may include a register file including one or more sets of registers for one or more data types specified by the ISA implemented by the processor. The processor may have a processor mode in which the context is reduced, as compared to the full context. For example, for at least one of the data types, the registers included in the reduced context exclude one or more of the registers defined in the ISA for that data type. In an embodiment, one half or more of the registers for the data type may be excluded. When the processor is operating in a reduced context mode, the processor may detect instructions that use excluded registers, and may signal an exception for such instructions to prevent use of the excluded registers.

### BACKGROUND

### Technical Field

Embodiments described herein are related to processors, and more particularly to context switching in processors.

### Description of the Related Art

Processors are designed to an instruction set architecture (ISA). The ISA defines a set of instructions, including the behavior of each instruction (i.e. the operands of the instruction, the operation(s) performed, the result, any exception conditions and how they are reported, etc.), the coding of the instruction in memory (i.e. so that the processor can distinguish between the instructions defined in the ISA for execution), and various other processor state that can affect the instruction execution (e.g. various modes, configuration register values, etc.). The ISA defines a set of processor state. The processor state can have a predefined set of values at reset (i.e., the values taken on by the various resources in the processor state at reset can be defined in the ISA), although some state may be considered undefined at reset (e.g. the reset may not force a particular value into that resource). Undefined state can be initialized though instruction execution. After the execution of one or more instructions defined in the ISA, generally the processor state has been modified to reflect the result of the one or more instructions. In some cases, an exception condition can result in undefined state or unpredictable state, as defined in the ISA. The unpredictable/undefined state can be reinitialized via further instruction execution. The ISA can serve as the interface between software (programmed using the instructions in the ISA) and processor hardware (which implements the ISA). Software written to the ISA can be executed correctly on various different implementations of the ISA.

The architected state of the processor is included in a context of the processor. The context at a given point in the execution of a program is the result of executing the instructions in the program prior to that point. A process is an instance of a program, and can have one or more threads of execution according to the program's design. If a process/thread is interrupted on the processor to execute another process/thread, the context can be saved to memory so that the process/thread can continue execution from the interrupted point, either on the same processor or another processor, by loading the context from memory to that processor.

The architected state includes a variety of registers that can be used to store operands and instruction execution results for instructions. In many ISAs, there are multiple sets of registers for different data types (e.g. integer, floating point, vector, etc.). Accordingly, the size of the context can be significant. The memory footprint (i.e. the amount of memory consumed) for saved contexts can be a significant portion of the available memory, especially for processors using a local memory that is separate from the main memory in a system. Additionally, reading and writing the context consumes power, which can be an issue in systems that operate (at least part of the time) from a finite energy supply such as a battery. Still further, the amount of time consumed by reading and writing contexts affects the performance of program execution in the processor. The performance impacts increase with the frequency of the context switching.

### SUMMARY

In an embodiment, a processor may include a register file including one or more sets of registers for one or more data types specified by the ISA implemented by the processor. The processor may have a processor mode in which the context is reduced, as compared to the full context. For example, for at least one of the data types, the registers included in the reduced context exclude one or more of the registers defined in the ISA for that data type. In an embodiment, one half or more of the registers for the data type may be excluded. When the processor is operating in a reduced context mode, the processor may detect instructions that use excluded registers, and may signal an exception for such instructions to prevent use of the excluded registers.

In an embodiment, the reduced context may reduce the memory footprint for processes by reducing the amount of memory consumed by the context. In an embodiment, the performance of context switches using the reduced context may increase, since the amount of data read and written is reduced. In an embodiment, power consumed by the context switches may also be reduced since the reading/writing of memory is reduced.

### BRIEF DESCRIPTION OF THE DRAWINGS

The following detailed description makes reference to the accompanying drawings, which are now briefly described.

FIG. 1 is a block diagram of one embodiment of a portion of a processor.

FIG. 2 is a block diagram of one embodiment of a full processor context and embodiments of a reduced processor context.

FIG. 3 is a flow chart illustrating a context switch in one embodiment of the processor shown in FIG. 1.

FIG. 4 is a flowchart illustrating operation of one embodiment of the processor shown in FIG. 1 to execute an instruction.

FIG. 5 is a block diagram of one embodiment of a system on a chip (SOC) that includes multiple instances of the processor shown in FIG. 1.

FIG. 6 is a block diagram of one embodiment of a system that includes instances of the processor shown in FIG. 1.

FIG. 7 is a block diagram of one embodiment of a computer accessible storage medium.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to. As used herein, the terms “first,” “second,” etc. are used as labels for nouns that they precede, and do not imply any type of ordering (e.g., spatial, temporal, logical, etc.) unless specifically stated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “clock circuit configured to generate an output clock signal” is intended to cover, for example, a circuit that performs this function during operation, even if the circuit in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible. In general, the circuitry that forms the structure corresponding to “configured to” may include hardware circuits. The hardware circuits may include any combination of combinatorial logic circuitry, clocked storage devices such as flops, registers, latches, etc., finite state machines, memory such as static random access memory or embedded dynamic random access memory, custom designed circuitry, analog circuitry, programmable logic arrays, etc. Similarly, various units/circuits/components may be described as performing a task or tasks, for convenience in the description. Such descriptions should be interpreted as including the phrase “configured to.”

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims a unit/circuit/component or other structure that is configured to perform one or more tasks is expressly intended not to invoke 35 U.S.C. § 112(f) interpretation for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In an embodiment, hardware circuits in accordance with this disclosure may be implemented by coding the description of the circuit in a hardware description language (HDL) such as Verilog or VHDL. The HDL description may be synthesized against a library of cells designed for a given integrated circuit fabrication technology, and may be modified for timing, power, and other reasons to result in a final design database that may be transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and may further include other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA.

As used herein, the term “based on” or “dependent on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

### DETAILED DESCRIPTION OF EMBODIMENTS

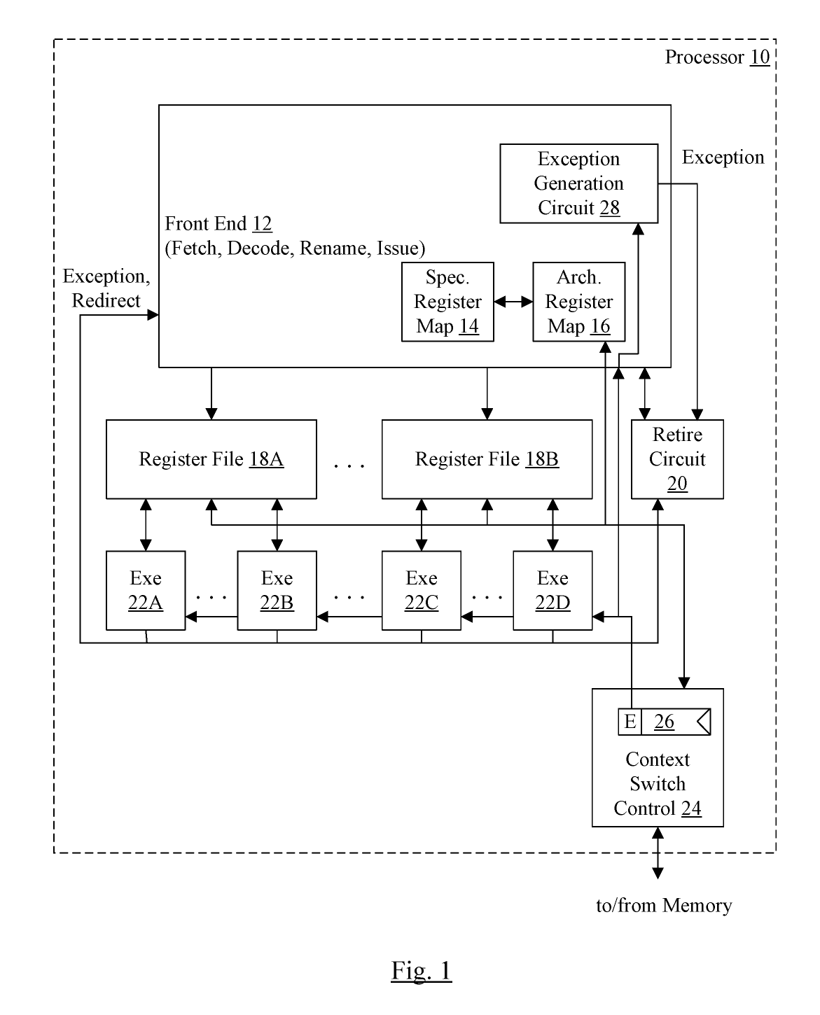

Turning now to FIG. 1, a block diagram of a portion of one embodiment of a processor 10 is shown. In the illustrated embodiment, the processor 10 includes a front end circuit 12 (which includes a speculative register map 14, an architected register map 16, and an exception generation circuit 28), register files 18A-18B, a retire circuit 20, execution circuits 22A-22D, and a context switch control circuit 24 (which includes a configuration register 26). In the embodiment of FIG. 1, the front end circuit 12 is coupled to the register files 18A-18B, the retire circuit 20, the execution circuits 22A-22D, and the context switch control circuit 24. The register file 18A is coupled to the execution circuits 22A-22B, and the register file 18B is coupled to the execution circuits 22C-22D. The register files 18A-18B and are also coupled to the context switch control circuit 24, which is further coupled to the execution circuits 22A-22D, the front end circuit 12 and particularly to the architected register map 16 in the front end circuit 12. The exception generation circuit 28 is coupled to the register 26 (e.g. receiving the enable indication).

The context switch control circuit 24 is configured to perform context switch operations (or more briefly, context switches) for the processor 10. The context switch may generally include writing the context of the currently executing process to memory (e.g. a “context save area” in memory) and reading another context from memory (e.g. a “context restore area” for this particular context switch, although the context restore area may also be a context save area from a previous context switch, or a new context created for a process that is beginning its initial execution). A pointer (not shown in FIG. 1) may indicate where the current context is to be stored and another pointer (also not shown in FIG. 1) may be provided to the context switch control circuit 24 to identify the location from which to read the new context. The context switch control circuit 24 may include hardware (e.g. one or more state machines) that read the context from various processor resources and transmit write operations to write the data to memory, and that transmit read operations to read the context from memory and write the context to the various processor resources. Alternatively, the context switch control circuit 24 may include microcode or other instruction-injection mechanisms to inject instructions into the processor 10 pipeline (e.g. load and store instructions) to write the context to memory and read the context from memory. A combination of hardware state machines and instruction injection may be used in other embodiments. Still further, in some embodiments, the transfer of context to the context save area and from the context restore area may be implemented in software. The software may be privileged software (e.g. the operating system software, kernel software, etc.), to protect the contexts against possible corruption by user code. The software may include a series of instructions to read the register files 18A-18B and write the context save area, and to read the context restore area and write the register files 18A-18B. Based on the enable indication in the register 26, the software may read/write reduced context for one or more register files 18A-18B. When the context switch is implemented in software, the context switch control circuit 24 may not be required. The register 26 may be located, e.g., in or near the exception generation circuit 28.

Context switches may occur in response to certain types of external interrupts, for example. The interrupt may be sourced by a peripheral component that is requesting service. The interrupt may also be sourced by a timer circuit programmed by an operating system to switch out a process that has been executing for a period of time, in order to switch in another process to execute on the processor 10. Any mechanism for signaling context switches may be used. The portion of the context switch that stores the current context to memory may be referred to as a context save operation (or more briefly a context save); and the portion of the context switch that loads a different context from memory may be referred to as a context restore operation (or more briefly a context restore).

FIG. 1 illustrates the context switch control circuit 24 transmitting and receiving to/from memory. In an embodiment, the processor 10 may include an interface circuit configured to interface to the memory subsystem (e.g. a memory controller that is coupled to memory forming the main memory in the system or a local memory in a component of the system, various lower level caches that are external to the processor 10, if any, etc.). The interface circuit may further be configured to perform read and write operations for load and store instruction operations executed by one or more of the execution circuits 22A-22D, and to perform read operations to fetch instructions for execution. The processor 10 may include a data cache (not shown) to cache load/store data, and/or an instruction cache to store fetched instructions.

The context of the processor may generally include the processor state that reflects execution of instructions in a process. If the process is interrupted and the context is saved and later restored, the process may continue execution after the restoration at the next instruction in the process (i.e. the instruction following the instruction after which the process was interrupted) and the result of the process is the same as if the process executed from beginning to end without interruption. The context may include the architected state of the processor. The architected state is the state defined in the ISA implemented by the processor. The architected state may include various configuration/control registers. The configuration/control registers may include special purpose registers and/or model-specified registers that may be programmed with various processor modes. A processor mode may be any programmable configuration which affects the operation of the processor in a desired fashion. For example, a processor mode may impact the execution of all instructions, or all instructions that operate on a particular data type, or all instruction of another defined subset that includes multiple instructions. On the other hand, operands affect the operation (e.g. the result) of a single instruction, for example. The architected state may also include one or more sets of registers, each of a different data type defined in the ISA. A data type defines how the processor interprets the bits stored in the register. For example, an integer data type interprets the bits as an integer. A floating point data type interprets the bits as a floating point number (e.g. a sign bit, exponent bits, and mantissa bits). A vector data type interprets the bits as multiple independent numbers abutting each other in the register. The numbers may be various types, including integer and floating point, for example. The registers in the sets of registers may be used as operands for the instructions defined in the ISA (e.g. explicitly coded into the instruction, implicitly referenced by the instruction, etc.). Thus, an instruction that operates on a particular data type may use operands from the corresponding set of registers.

In an embodiment, the register 26 is one of the configuration/control registers and stores an indication of a processor mode (e.g. one or more reduced context modes and a full context mode). The register 26 may be programmed to indicate if the processor 10 is operating with a reduced context or a full context. For example, in the embodiment of FIG. 1, the register 26 may include an enable bit to enable reduced context. Thus, the enable bit may be set to indicate reduced context and clear to indicate full context. Other embodiments may use the opposite senses of the bit, or may use multi-bit encodings. For example, a multibit encoding may be used if there is more than one definition of the reduced context. If more than one data type supports a reduced context, for example, the enable encoding may include a bit or bits per data type to indicate reduced contexts or a full context. Alternatively, multibit encodings may be used to encode different selections of reduced context, as well as a full context encoding.

In one embodiment, the reduced context may include fewer, but more than zero, registers for at least one of the data types supported by the processor 10. For example, the number of registers may be the architected number (as specified in the ISA) divided by a power of 2 (e.g. ½ of the architected registers, ¼ of the architected registers, etc.). Any amount of reduced context may be supported, and multiple levels of reduced context may be supported, in various embodiments. In an embodiment, reduced context may be supported for more than one data type. The reduction may be the same for each data type, or different amounts of reduction may be supported for different data types, in various embodiments.

The reduced context allows for instructions using the data type to be executed, but reduces the registers that may be used for operands/results. If code being executed by the processor 10 uses the data type but not as frequently as other data types, the reduced context may provide sufficient state to support performance while also reducing the amount of data saved and restored for the contexts. In contrast, a full context may include all of the architected registers for each data type.

Since the reduced context excludes some architected registers, the values in those excluded registers are not saved or restored in the context save/restore operations. Thus, the values in the registers may be unpredictable and should not be used. Particularly, the data in the excluded registers may different between a context save for a given context and the ensuing context restore of the given context. In an embodiment, the processor 12 may generate an exception if the reduced context is enabled and one of the excluded registers is used in an instruction (e.g. as a source operand or a destination). In particular, the exception generation circuit 28 may receive the enable indication from the register 28, and may examine the operands used by each instruction. If an excluded register is used, the exception generation circuit 28 may signal the exception for the instruction. While the exception generation circuit 28 is illustrated in FIG. 1 in the front end circuit 12, the exception generation circuit 28 may generally implemented at any point in the instruction processing pipeline of the processor 10 before the results of instructions are committed (e.g. at retirement of the instruction).

The front end circuit 12 may generally include the hardware to fetch instructions, decode the instructions, perform register renaming (for embodiments that implement register renaming) and issue instruction operations for execution. In an embodiment, the front end circuit 12 may include an instruction cache configured to store instructions fetched (or prefetched) by the processor 10. The front end circuit 12 may include various branch prediction mechanisms to predict branch instructions (e.g. taken or not taken, and/or the branch target address for indirection branch instruction, call/return instructions, etc.). If the front end circuit 12 detects misspeculation or other exception conditions, the front end circuit 12 may flush the incorrectly fetched instructions and redirect fetch to the correct instructions (or may fetch instructions at the exception vector, in the case of an exception). The front end circuit 12 may indicate the exception or redirect to the retire circuit 20, which may track the in-order sequence of instructions and ensure the correct retirement of the instructions when execution is complete and the exception conditions have been cleared. The retirement of an instruction may include committing the results of the instruction to architected state, and thus the instruction's effect on the processor state may be complete and any subsequent redirect or exception may not undo the effect.

In one embodiment, the exception conditions detected by the front end circuit 12 may include the use of a register by an instruction (as a source operand or a destination for results) if the register is not included in the reduced context and the reduced context is enabled in the register 26. As mentioned previously, the exception generation circuit 28 may detect this exception. In other embodiments the execution circuits 22A-22D may detect the exception (and thus the exception generation circuit 28, or multiple instances of the circuit 28, may be included in the execution circuits 22A-22D). The execution circuits 22A-22D may also detect other exceptions/redirects (e.g. branch mispredictions, exceptions on load/store operations, etc.), which the execution circuits 22A-22D may report to the retire circuit 20 and the front end circuit 12.

The front end circuit 12 may decode the instructions. In an embodiment, the front end circuit 12 may decode each instruction into one or more instruction operations. Generally, an instruction operation may be an operation that the execution circuits 22A-22D are designed to perform. In some embodiments, a given instruction may be decoded into one or more instruction operations, depending on the complexity of the instruction. Particularly complex instructions may be microcoded, in some embodiments. In such embodiments, the microcode routine for the instruction may be coded in instruction operations. In other embodiments, each instruction in the instruction set architecture implemented by the processor 10 may be decoded into a single instruction operation, and thus the instruction operation may be essentially synonymous with instruction (although it may be modified in form by the decoder). The term “instruction operation” may be more briefly referred to herein as “op.”

The architected registers determined, by the decoders, to be referenced by a given op may be mapped to physical registers via register renaming. That is, there may be more physical registers of a given data type than the number of architected registers defined in the ISA for the given data type, and the results of speculative instructions may be written to the register files 18A-18B speculatively. A current speculative copy of the mapping of architected registers to physical registers may be represented in the speculative register map 14. As ops that update registers have those registers renamed, the speculative register map 14 may be updated to indicate the mappings assigned by the renamer. Additionally, source register for each op may be renamed in the op by reading the speculative register map for each architected source register. Ops that are renamed in parallel may override the speculative register map 14 if an older instruction (in program order) that is being renamed in parallel writes a register that is a source of a younger instruction. The architected register map 16, on the other hand, may store the mapping of physical registers to architected registers based on the most recently retired instruction. Accordingly, as ops are retired, the architected register map 16 may be updated to reflect the destination registers that have been written by the retired ops, associating the physical register written by the ops with the architected register. Accordingly, when an exception or other interrupt occurs, the ops prior to the op on which the exception/interrupt is taken (and the op on which the interrupt is taken, for interrupts and some exceptions) may be retired. The architected register map 16 at that point may indicate the current architected state of the processor 10 for the registers. The exception/interrupt may be taken and the architected register map 16 may be copied to the speculative register map 14.

Additionally, in the case of a context switch, the ops up to and include the op on which the context switch occurs may be retired. The architected register map 16 at that point may indicate which physical registers in the register files 18A-18B store the architected state of the processor 10. The context switch control circuit 24 may use the architected register map to read the corresponding physical registers for each architected register in the full context or reduced context. In an embodiment, the context restore operation may also write the same physical registers with restored context. In another embodiment, the rename circuit in the front end circuit 12 may assign different physical registers to the restored context. In an embodiment, the assignment of different physical registers may allow the context save and restore operations to occur in parallel, and execution in the restored context may even begin prior to the completion of the context save operation. For example, if the rename circuit assigns physical registers from a free list, the physical register storing the context being saved may not be added to the free list until the values are stored to the context save area in memory.

The ops may be issued by the front end circuit 12 for execution. In an embodiment, the front end circuit 12 may include a centralized scheduler that determines when each op has its dependencies satisfied, and may schedule the op at any point after the dependencies are satisfied. The dependencies may be satisfied if the source operands are available in the register files 18A-18B or if the source operands will be available for forwarding to the op prior to the op reaching the execution circuits 22A-22D. Alternatively, there may be reservation stations for each execution circuit 22A-22D, either before the register files 18A-18B in the pipeline or after the register files 18A-18B.

As mentioned above, the register files 18A-18B may include physical registers for various data types. For example, the register file 18A may include integer physical registers, while the register file 18B may include floating point physical registers or vector physical registers. Any set of data types may be supported in various embodiments, based on the ISA implemented by the processor 10. In embodiments that implement register renaming, the physical registers may be the rename registers and the maps 14 and 16 may map the architected registers to the physical registers. In other embodiments, the processor 10 may use a reorder buffer to store speculative results and the architected registers may have a one-to-one, fixed mapping to registers in the register files 18A-18B. In still other embodiments, the processor 10 may employ in-order execution and the architected registers may have a one-to-one, fixed mapping to registers in the register files 18A-18B. In such embodiments, the context switch control circuit need not consult a register map to read the context from the register files 18A-18B and write the context to the register files 18A-18B. In an embodiment, the register files 18A-18B may be implemented as independent memory arrays or other storage devices (e.g. registers, latches, flip-flops, etc.). Alternatively, one or more register files 18A-18B may be implemented as one memory array or other storage devices.

The execution circuits 22A-22D may each include circuitry to execute one or more ops. The execution circuits 22A-22D may be arranged by data type. For example, the execution circuits 22A-22B may be integer execution circuits; the execution circuits 22C-22D may be floating point execution circuits, other execution circuits (not shown) may be vector execution circuit; etc. The number of execution circuits may differ for different data types. The execution circuits may be symmetrical (e.g. each execution circuit of a given data type may be configured to execute the same set of ops) or asymmetrical (e.g. different execution circuits may be configured to execute different subsets of ops that operate on the data type).

The retire circuit 20 may manage the in-order retirement of instructions/ops, for embodiments that implement out-of-order execution. The retire circuit 20 may ensure that ops prior to an exception/interrupt are completed and retired prior to the interrupt/exception being taken (and may also ensure that no subsequent ops are retired). Similarly, the retire circuit 20 may ensure that the instruction/ops prior to a context switch have retired prior to performing the context switch (and may also ensure that no subsequent ops are retired). In an embodiment, the retire circuit 20 may implement a reorder buffer-like structure to update the architected register map 16 as instructions/ops are completed and retired. In-order embodiments need not include a retire circuit 20.

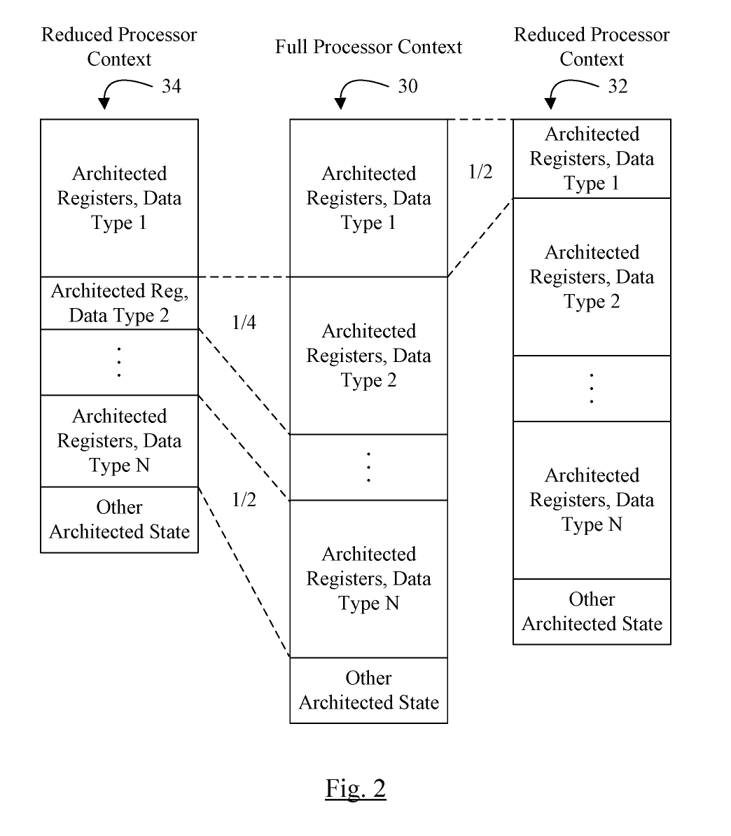

FIG. 2 is an example of an embodiment of a full processor context 30 stored in memory, and example embodiments of reduced processor contexts 32 and 34 stored in memory as well.

In the embodiment shown, the full processor context 30 includes areas storing the values from the architected registers of each data type (e.g. data types 1 to N in FIG. 2). For example, an embodiment having integer, floating point, and vector data types has 3 data types. Additionally, other architected state such as configuration/control registers that are included in the context may be stored in the full context 30. While the illustrated embodiment includes the other architected state after the sections for the architected registers of different data types, the architected state may be stored before the sections for the architected registers in other embodiments or may be interleaved between the sections.

The reduced processor context 32 includes areas for architected registers of each data type, and the other architected state. However, ½ of the registers for data type 1 are included (e.g. the other half of the registers are excluded). For example, if there are M registers of data type 1, the register numbers 0 to M/2−1 may be included, and register numbers M/2 to M−1 may be excluded. In other embodiments, the register numbers 0 to M/2−1 may be excluded and M/2 to M−1 may be included, the odd-numbered registers may be excluded and the even-numbered registers may be included, or the odd-numbered registers may be included and the even-numbered registers may be excluded. Any mechanism for identifying which registers are included or excluded may be used.

As can be seen visually in FIG. 2, reducing that amount of context state stored for each context may reduce the memory footprint of the context. It is noted that the reduction may not be to scale in FIG. 2. For example, in some embodiments, reducing the context of certain data types (e.g. vector floating point data types) may reduce the context for some ISAs by as much as ⅔.

In various embodiments, more than one data type may have reduced context, and/or different data types may be reduced by different amounts. The reduced context 32, for example, reduces that context for data type 2 to ¼ of the full context for that data type, and data type N by ½. Any amount of reduction for any number of data types may be supported. The determination of which data types to reduce, and the size of the reduction, may be based on the frequency of use of the data types in expected workloads, the expected footprint reduction for the context (which may affect the amount of time required to save/restore the context, power expended saving and, restoring context, the memory consumed for saved contexts, etc.), etc.

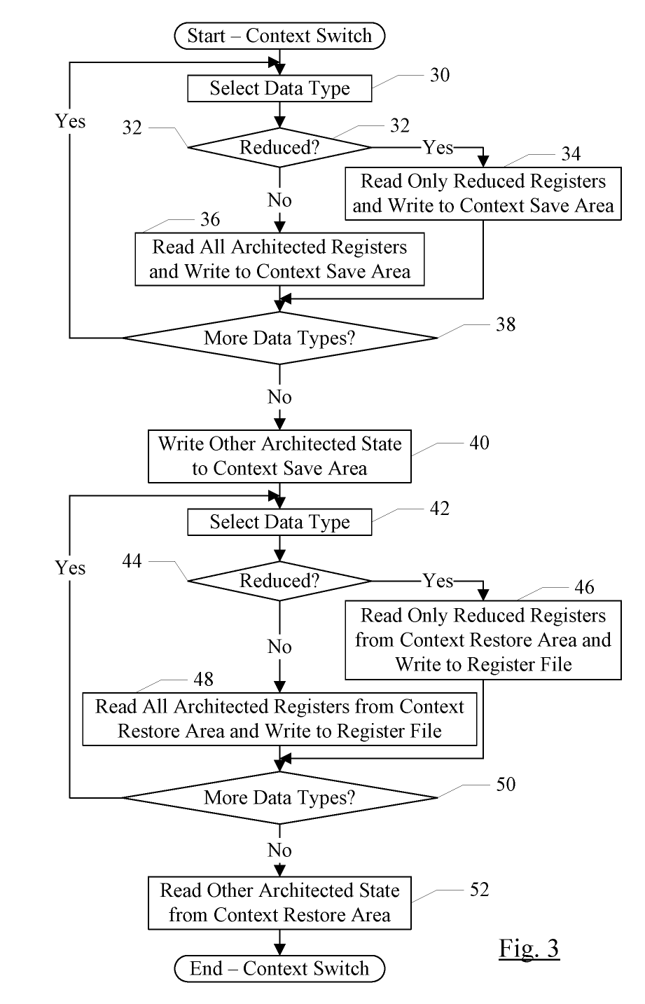

FIG. 3 is a flowchart illustrating operation of one embodiment of the context switch control circuit 24 and/or other components of the processor 10 to perform a context switch. In embodiments in which instructions are used to perform the context switch, FIG. 3 may illustrate operation of the instructions, when executed in response to detection of a context switch. While the blocks are shown in a particular order for ease of understanding, other orders may be used. Blocks may be performed in parallel in combinatorial logic within the processor 10. Blocks, combinations of blocks, and/or the flowchart as a whole may be pipelined over multiple clock cycles. The context switch control circuit 24 and/or the processor 10 may be configured to implement the operation shown in FIG. 3.

The context switch control circuit 24 may select a data type for which to save the registers (block 30). If the reduced context is enabled (via register 26) (decision block 32, “yes” leg), the context switch control circuit 24 may read the reduced register set, excluding the registers that are not included in the reduced context, and may write the values from the reduced register set to the context save area (block 34). If the reduced context is not enabled (decision block 32, “no” leg), or if the data type is one for which the reduced context and the full context are the same, the context switch control unit 26 may read all the architected registers for that data type and write the values to the context save area (block 36). If there are additional data types to save (decision block 38, “yes” leg), the context switch control circuit 24 may repeat blocks 30, 32, 34, and 36 for the next data type. Thus, for an ISA that specifies N data types, blocks 30, 32, 34, and 36 may be repeated N times. In some embodiments, data types may be processed in parallel. Once the data types have been processed (decision block 38, “no” leg), the context switch control circuit 24 may read the other architected state (e.g. configuration/control registers that are part of the context) and write the values to the context save area (block 40).

The context switch control circuit 24 may also perform the context restore of the new context. The context pointer in the context switch control circuit may be changed to point to the context restore area storing the new context (e.g. specified by a pointer in an ISA-dependent fashion as part of the context switch). The context restore operation may include selecting each data type (block 42), determining if the reduced context is enabled (decision block 44), reading the values for the reduced register set from the context save area if the reduced context is enabled and writing the reduced register set in the register file 18A-18B (block 46), or restoring all the architected registers if the reduced context is not enabled or the reduced context is the same as the full context for the data type (block 48), and repeating blocks 42, 44, 46, and 48 for each data type (e.g. N times—decision block 50, which may be performed in parallel in other embodiments), followed by reading the other architected state from the context restore area and storing in to the appropriate registers (block 52).

In the case of the context restore, the determination of whether or not the reduced context is enabled (decision block 44) may be based on the contents of the register 26 in the new context. That is, the context switch control circuit 24 may be configured to read the value of the register 26 from the new context prior to beginning the restore process (e.g. prior to block 40). Alternatively, the reduced context enable/disable (or selection from multiple forms of reduced context, in some embodiments) may be considered to be a relatively static choice programmed into the processor 10 during initialization and remaining the same across contexts.

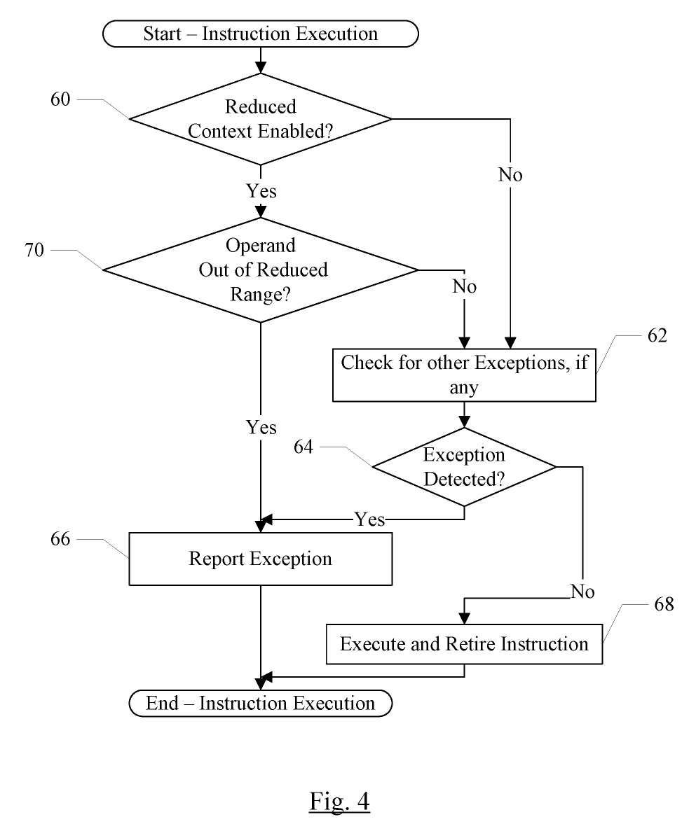

FIG. 4 is a flowchart illustrating operation of one embodiment of a processor to execute an instruction. While the blocks are shown in a particular order for ease of understanding, other orders may be used. Blocks may be performed in parallel in combinatorial logic within the processor 10. Blocks, combinations of blocks, and/or the flowchart as a whole may be pipelined over multiple clock cycles. The processor 10 and/or various components thereof (e.g. the exception generation circuit 28) may be configured to implement the operation shown in FIG. 4.

If the reduced context is not enabled in the processor 10 (decision block 60, “no” leg), the processor 10 may check for any other exceptions, if any other exceptions are defined in the ISA for the instruction (block 62). If an exception is detected (decision block 64, “yes” leg), the processor 10 may report the exception (block 66). If an exception is not detected (decision block 64, “no” leg), the processor 10 may execute the instruction (e.g. one or more ops representing the instruction) and subsequently retire the instruction assuming no preceding instructions case a redirect or exception (block 68).

On the other hand, if the reduced context is enabled (decision block 60, “yes” leg), the processor may check the register operands of the instruction to determine if any operand (source or destination) is outside the range of registers that are useable in the reduced context mode (decision block 70). If so (decision block 70, “yes” leg), the processor 10 may report the exception (block 66). If not (decision block 70, “no” leg), the processor 10 may check for any other exceptions and proceed as described above (blocks 62, 64, 66, and 68).

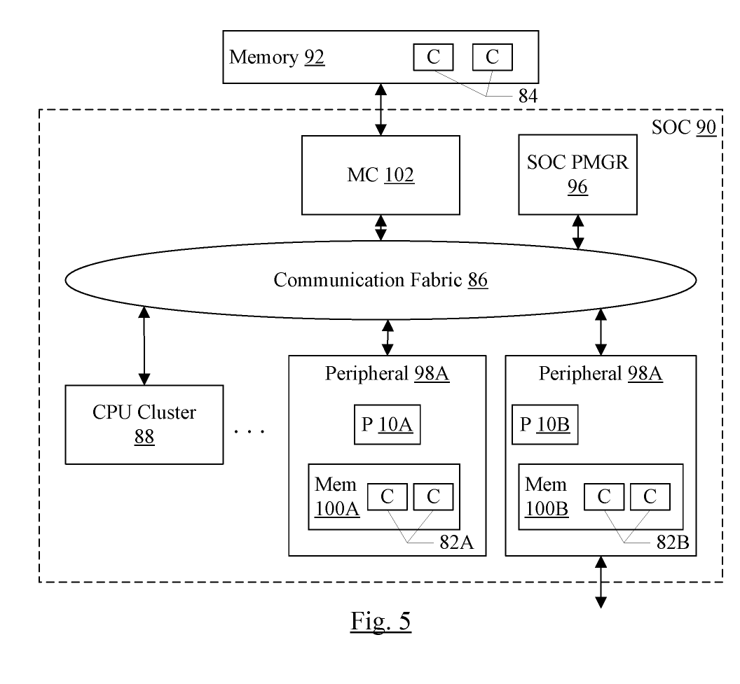

FIG. 5 is a block diagram of one embodiment of an SOC 90 coupled to a memory 92. As implied by the name, the components of the SOC 90 may be integrated onto a single semiconductor substrate as an integrated circuit “chip.” In some embodiments, the components may be implemented on two or more discrete chips in a system. However, the SOC 90 will be used as an example herein. In the illustrated embodiment, the components of the SOC 90 include one or more processors in a cluster 88 as the central processing unit(s) (CPUs) in the SOC 90, illustrated in FIG. 5 as the CPU cluster 88. In the illustrated embodiment, components of the SOC 90 further include peripheral components 98A-98B (more briefly, “peripherals” 98), a memory controller 102, an SOC power manager (PMGR) 96, and a communication fabric 86. The components 88, 96, 98A-98B, and 102 may all be coupled to the communication fabric 86. The memory controller 102 may be coupled to the memory 92 during use.

The memory controller 102 may generally include the circuitry for receiving memory operations from the other components of the SOC 90 and for accessing the memory 92 to complete the memory operations. The memory controller 102 may be configured to access any type of memory 92. For example, the memory 92 may be static random access memory (SRAM), dynamic RAM (DRAM) such as synchronous DRAM (SDRAM) including double data rate (DDR, DDR2, DDR3, DDR4, etc.) DRAM. Low power/mobile versions of the DDR DRAM may be supported (e.g. LPDDR, mDDR, etc.). The memory controller 102 may include queues for memory operations, for ordering (and potentially reordering) the operations and presenting the operations to the memory 92. The memory controller 102 may further include data buffers to store write data awaiting write to memory and read data awaiting return to the source of the memory operation. In some embodiments, the memory controller 102 may include a memory cache to store recently accessed memory data. In SOC implementations, for example, the memory cache may reduce power consumption in the SOC by avoiding reaccess of data from the memory 92 if it is expected to be accessed again soon. In some cases, the memory cache may also be referred to as a system cache, as opposed to private caches such as the shared cache or caches in the processors, which serve only certain components. Additionally, in some embodiments, a system cache need not be located within the memory controller 102.

The CPU cluster 88 may be configured to store CPU contexts in the memory 92 (e.g. the contexts 84 shown in FIG. 5). The peripherals 98A-98B may include instances of the processor 10 (e.g. processor 10A in the peripheral 98A and processor 10B in the peripheral 98B). A given peripheral may have more than one instance of the processor 10. Additionally, other components such as the SOC PMGR 96 may include instances of the processor 10. The peripherals 98A-98B may also include instances of a local memory 100A-100B. The memories 100A-100B may store contexts for the processors 10A-10B (e.g. the contexts 82A in the memory 100A and the contexts 82B in the memory 100B). In other embodiments, one or more components may include an instance of the processor 10 but no local memory, and the contexts for the processor 10 may be stored in the memory 92.

The workload of the processors 10A-10B may be characterized as having more frequent context switches than the workload of the CPU processors in the cluster 88. In some cases, the context switches may be much more frequent (e.g. one or more orders of magnitude more frequent). Additionally, the workload of processors 10A-10B may also be characterized by infrequent, but non-zero, use of one or more data types specified in the ISA. For example, in an embodiment, the workload may include infrequent, but non-zero use of vector registers. Accordingly, reducing the context saved and restored in the processors 10A-10B may be significant in terms of improved performance, reduced power consumption, and memory footprint. Improving performance is generally useful for any workload. Reducing power consumption may be desirable in SOCs that will be used in mobile devices or other devices that may operate from a limited power supply such as a battery. Additionally, reducing power consumption may reduce heat generation, which may be helpful in thermally-constrained systems. The size of the local memories 100A-100B may be limited, e.g. compared to the memory 92, and storage in the local memories 100A-100B may be used for other data besides the contexts 82A-82B, so reducing the context memory footprint may improve performance as well since more local memory space may be available for process data other than context save data.

The peripherals 98A-98B may be any set of additional hardware functionality included in the SOC 90. For example, the peripherals 98A-98B may include video peripherals such as an image signal processor configured to process image capture data from a camera or other image sensor, display controllers configured to display video data on one or more display devices, graphics processing units (GPUs), video encoder/decoders, scalers, rotators, blenders, etc. The peripherals may include audio peripherals such as microphones, speakers, interfaces to microphones and speakers, audio processors, digital signal processors, mixers, etc. The peripherals may include interface controllers for various interfaces external to the SOC 90 (e.g. the peripheral 98B) including interfaces such as Universal Serial Bus (USB), peripheral component interconnect (PCI) including PCI Express (PCIe), serial and parallel ports, etc. The peripherals may include networking peripherals such as media access controllers (MACs). Any set of hardware may be included.

The communication fabric 86 may be any communication interconnect and protocol for communicating among the components of the SOC 90. The communication fabric 86 may be bus-based, including shared bus configurations, cross bar configurations, and hierarchical buses with bridges. The communication fabric 86 may also be packet-based, and may be hierarchical with bridges, cross bar, point-to-point, or other interconnects.

The SOC PMGR 96 may be configured to control the supply voltage magnitudes requested from the PMU in the system. There may be multiple supply voltages generated by the PMU for the SOC 90. For example, the a voltage may be generated for the CPU cluster 88, and another voltage may be generated for other components in the SOC 90. In an embodiment, the other voltage may serve the memory controller 102, the peripherals 98A-98B, the SOC PMGR 96, and the other components of the SOC 90 and power gating may be employed based on power domains. There may be multiple supply voltages for the rest of the SOC 90, in some embodiments. In some embodiments, there may also be a memory supply voltage for various memory arrays in the CPU cluster 88 and/or the SOC 90. The memory supply voltage may be used with the voltage supplied to the logic circuitry, which may have a lower voltage magnitude than that required to ensure robust memory operation.

It is noted that the number of components of the SOC 90 may vary from embodiment to embodiment. There may be more or fewer of each component/subcomponent than the number shown in FIG. 5.

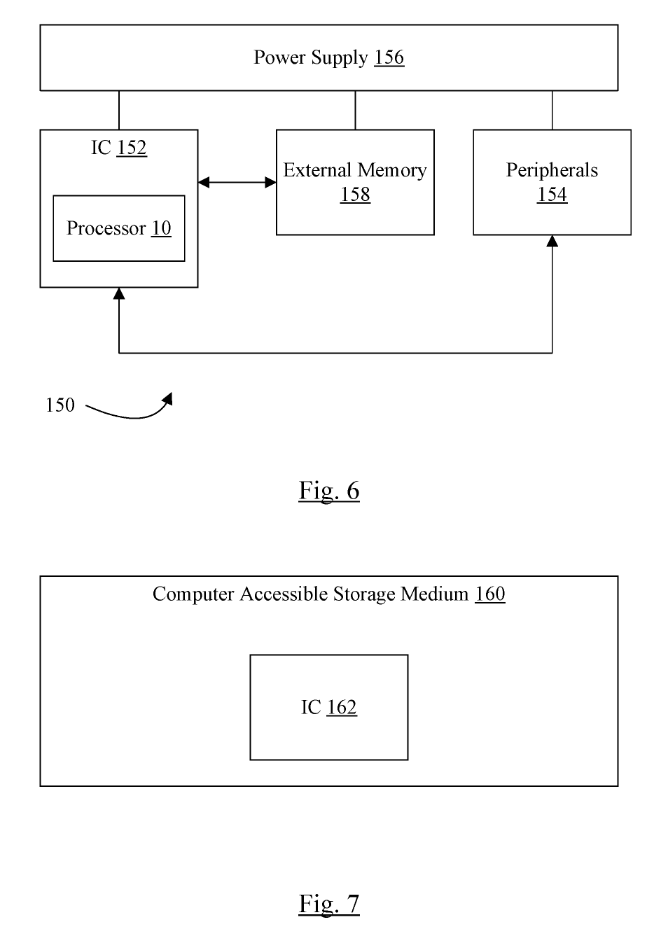

Turning next to FIG. 6, is a block diagram of one embodiment of a system 150. In the illustrated embodiment, the system 150 includes at least one instance of an integrated circuit (IC) 152 coupled to one or more peripherals 154 and an external memory 158. A power supply 156 is provided which supplies the supply voltages to the IC 152 as well as one or more supply voltages to the memory 158 and/or the peripherals 154. The IC 152 may include one or more instances of the processor 10. In other embodiments, multiple ICs may be provided with instances of the processor 10.

The peripherals 154 may include any desired circuitry, depending on the type of system 150. For example, in one embodiment, the system 150 may be a computing device (e.g., personal computer, laptop computer, etc.), a mobile device (e.g., personal digital assistant (PDA), smart phone, tablet, etc.), or an application specific computing device. In various embodiments of the system 150, the peripherals 154 may include devices for various types of wireless communication, such as wifi, Bluetooth, cellular, global positioning system, etc. The peripherals 154 may also include additional storage, including RAM storage, solid state storage, or disk storage. The peripherals 154 may include user interface devices such as a display screen, including touch display screens or multitouch display screens, keyboard or other input devices, microphones, speakers, etc. In other embodiments, the system 150 may be any type of computing system (e.g. desktop personal computer, laptop, workstation, net top etc.).

The external memory 158 may include any type of memory. For example, the external memory 158 may be SRAM, dynamic RAM (DRAM) such as synchronous DRAM (SDRAM), double data rate (DDR, DDR2, DDR3, etc.) SDRAM, RAMBUS DRAM, low power versions of the DDR DRAM (e.g. LPDDR, mDDR, etc.), etc. The external memory 158 may include one or more memory modules to which the memory devices are mounted, such as single inline memory modules (SIMMs), dual inline memory modules (DIMMs), etc. Alternatively, the external memory 158 may include one or more memory devices that are mounted on the IC 152 in a chip-on-chip or package-on-package implementation. The memory 158 may include the memory 92 shown in FIG. 5.

FIG. 7 is a block diagram of one embodiment of a computer accessible storage medium 160 storing an electronic description of the IC 152 (reference numeral 162) is shown. More particularly, the description may include at least the processor 10. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, or Flash memory. The storage media may be physically included within the computer to which the storage media provides instructions/data. Alternatively, the storage media may be connected to the computer. For example, the storage media may be connected to the computer over a network or wireless link, such as network attached storage. The storage media may be connected through a peripheral interface such as the Universal Serial Bus (USB). Generally, the computer accessible storage medium 160 may store data in a non-transitory manner, where non-transitory in this context may refer to not transmitting the instructions/data on a signal. For example, non-transitory storage may be volatile (and may lose the stored instructions/data in response to a power down) or non-volatile.

Generally, the electronic description 162 of the IC 152 stored on the computer accessible storage medium 160 may be a database which can be read by a program and used, directly or indirectly, to fabricate the hardware comprising the IC 152. For example, the description may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the IC 152. The netlist may then be placed and routed to produce a data set describing geometric shapes to be applied to masks. The masks may then be used in various semiconductor fabrication steps to produce a semiconductor circuit or circuits corresponding to the IC 152. Alternatively, the description 162 on the computer accessible storage medium 300 may be the netlist (with or without the synthesis library) or the data set, as desired.

While the computer accessible storage medium 160 stores a description 162 of the IC 152, other embodiments may store a description 162 of any portion of the IC 152, as desired (e.g. the processor 10, as mentioned above).

Numerous variations and modifications will become apparent to those skilled in the art once the above disclosure is fully appreciated. It is intended that the following claims be interpreted to embrace all such variations and modifications.

What is claimed is:

1. A processor, comprising:
a plurality of register files that store at least a portion of a processor context of the processor during use, wherein a first register file of the plurality of register files corresponds to a first plurality of registers that store data of a first data type defined in an instruction set architecture (ISA) implemented by the processor, and wherein a second register file of the plurality of registers corresponds to a first plurality of registers that store data of a second data type defined in the ISA, wherein a full processor context for the processor includes data from the first plurality of registers of the first data type and data from the second plurality of registers of the second data type;
a control register that stores an indication of a first processor mode during use, wherein a reduced processor context in the first processor mode excludes one or more first registers of the first plurality of registers and includes at least one second register of the first plurality of registers; and
an exception detection circuit coupled to the control register, wherein the exception detection circuit signals an exception for a first instruction that uses at least one of the one or more first registers responsive to the first processor mode.

2. The processor as recited in claim 1 wherein the processor implements register renaming, and wherein a mapping of a third plurality of registers in the first register file to the first plurality of registers is specified by a first circuit that implements the register renaming.

3. The processor as recited in claim 1 wherein the first register file includes a third plurality of registers having a fixed mapping to the first plurality of registers.

4. The processor as recited in claim 1 wherein the reduced processor context includes each of the second plurality of registers.

5. The processor as recited in claim 1 wherein the reduced processor context excludes one or more third registers of the second plurality of registers and includes at least one fourth register of the second plurality of registers.

6. The processor as recited in claim 5 wherein a first number of the one or more first registers differs from a second number of the one or more third registers.

7. The processor as recited in claim 1 wherein a first number of the one or more first registers is a second number of architected registers specified by the ISA for the first data type divided by a power of two.

8. The processor as recited in claim 1 further comprising a context switch control circuit coupled to the plurality of register files, wherein the context switch control circuit is configured to perform a context switch in the processor, and wherein the control circuit is configured to save the reduced context responsive to the first processor mode.

9. The processor as recited in claim 8 wherein the context switch control circuit is configured to save the full context including each of the first plurality of registers in a second processor mode indicated in the control register.

10. An integrated circuit comprising:
one or more first processors in a central processing unit (CPU) cluster of the integrated circuit; and
a plurality of peripherals coupled to the CPU cluster, wherein the plurality of peripherals each include one or more second processors that, in a first processor mode, support a reduced context that excludes one or more first registers of a first plurality of registers for a first data type specified in an instruction set architecture (ISA) implemented by the one or more second processors, wherein the reduced context includes other ones of the first plurality of registers, and wherein the one or more second processors are configured to take an exception for a first instruction that uses one of the one or more first registers in the first processor mode.

11. The integrated circuit as recited in claim 10 wherein a first peripheral of the plurality of peripherals further comprises a local memory coupled to the one or more second processors and configured to store one or more reduced contexts from the one or more second processors.

12. The integrated circuit as recited in claim 11 wherein the local memory is further configured to store one or more full contexts from the one or more second processors, wherein the one or more second processors are support a full context in a second processor mode.

13. The integrated circuit as recited in claim 10 wherein the one or more second processors include a second plurality of registers for a second data type specified in the ISA.

14. The integrated circuit as recited in claim 13 wherein the reduced context excludes one or more second registers of the second plurality of registers.

15. The integrated circuit as recited in claim 13 wherein the reduced context includes each of the registers in the second plurality of registers.

16. The integrated circuit as recited in claim 10 wherein a first number of the one or more first registers is a second number of architected registers specified by the ISA for the first data type divided by a power of two.

17. The integrated circuit as recited in claim 10 where in the one or more second processors are configured to perform a reduced context switch in the first processor mode, wherein data from the one or more first registers is not saved in the reduced context switch.

18. A method comprising:
programming a processor with a first processor mode, wherein a first plurality of registers that store values of a first data type are partially included in a processor context for the processor in the first processor mode, wherein each of the first plurality of registers are included in the context for the processor in a second processor mode;
detecting use of a first register of the first plurality of registers while executing a first plurality of instruction in the first processor mode, wherein the first register is not included in the processor context in the first processor mode; and
taking an exception on a first instruction of the first plurality of instructions that uses the first register in the first processor mode, responsive to the detecting.

19. The method as recited in claim 18 wherein the partial inclusion of the first plurality of registers excludes one or more first registers of the first plurality of registers.

20. The method as recited in claim 18 wherein a second plurality of registers that store values of a second data type are fully included in the processor context in the first processor mode.
